(19) United States
(12) Patent Application Publication
(10) Pub. No.: US 2009/0232021 A1
(43) Pub. Date: Sep. 17, 2009

(54) WIRELESS NETWORK AUTOMATION: NETWORK TOPOLOGY LEARNING

(75) Inventor: Alexander Bachmutsky, Sunnyvale, CA (US)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Karaportti (FI)

(21) Appl. No.: 12/049,889

(22) Filed: Mar. 17, 2008

(51) Int. Cl. H04L 12/28

(52) U.S. Cl. 370/254

(57) ABSTRACT

Various example embodiments are disclosed. According to one example, a method may include receiving, by a gateway node, at least one base station message from each of a plurality of base stations, the base station messages each including a network identification (ID) of the sending base station. The method may further include generating a local table based on the base station messages. The local table may indicate the network IDs or Internet Protocol (IP) addresses of the base stations served by the gateway node. The method may further include sending the local table to each of a plurality of neighboring gateway nodes. The method may further include receiving a neighbor table from each of the neighboring gateway nodes. The method may further include generating a global table based on the local table and the neighbor tables.

### TECHNICAL FIELD

This description relates to wireless networks.

### BACKGROUND

In wireless networks, there may be a complex relationship between different nodes, such as Mobile Stations (MS), Base Stations (BS), Mobility Gateways (MG) and Service Core (SC). Some nodes (like MS) may be very mobile, and some may be less mobile, but may need significant provisioning to become a part of the wireless network. In addition, not all nodes may be allowed to communicate directly because of local policies, trust level or physical or logical connectivity restrictions. This dynamic and hierarchical nature of the network may make deployment, provisioning and routing within the network difficult.

### SUMMARY

According to one general aspect, a method may include receiving, by a gateway node serving a plurality of base stations which each wirelessly communicate with a plurality of mobile stations, at least one base station message from each of the base stations, the base station messages each including network identification (ID) of the sending base station. The method may further include generating a local table based on the base station messages. The local table may indicate the network IDs or Internet Protocol (IP) addresses of the base stations served by the gateway node. The method may further include sending a table message to each or subset of a plurality of served base stations and/or neighboring gateway nodes. The table message may include the local table. The method may further include receiving a neighbor table message from each or subset of the neighboring gateway nodes. The neighbor table messages may include neighbor tables indicating network IDs or IP addresses of the base stations served by each of the neighboring gateway nodes. The method may further include generating a global table based on the local table and the neighbor tables. The global table may indicate, for each of the base stations served by the gateway node or the neighboring gateway nodes, the network ID or IP address of the base station and which gateway node(s) serves the base station.

According to another general aspect, a gateway node may include a transceiver, a controller, and a memory. The transceiver may be configured to receive at least one base station message from each of a plurality of base stations which each wirelessly communicate with a plurality of mobile stations, the base station messages each including a network identification (ID) or Internet Protocol (IP) addresses of the sending base station. The transceiver may be configured to send a table message to each or subset of a plurality of served base stations and/or neighboring gateway nodes, the table message including a local table and network IDs or Internet Protocol (IP) addresses of the sending gateway node. The transceiver may be further configured to receive a neighbor table message from each or subset of the neighboring gateway nodes, the neighbor table messages including neighbor tables indicating network IDs or Internet Protocol (IP) addresses of base stations served by each of the neighboring gateway nodes. The controller may be configured to generate a local table based on the base station messages and/or configuration information containing network IDs or Internet Protocol (IP) addresses of base stations served by the particular gateway. The local table may indicate the network IDs or IP addresses of the base stations served by the gateway node. The controller may be further configured to generate a global table based on the local table and the neighbor tables. The global table may indicate, for each of the base stations served by the gateway node or the neighboring gateway nodes, the network ID or IP address of the base station and which gateway node(s) serves the base station. The memory may be configured to store the local table and the global table.

According to another general aspect, a computer program product for generating a global table of base stations may be tangibly embodied on a computer-readable medium and include executable code that, when executed, is configured to cause a gateway node which serves a plurality of base stations which each wirelessly communicate with a plurality of mobile stations to receive at least one base station message from each of the base stations or configuration information related to one or more served base stations, each including a network identification (ID) of the base station. The computer program product may be further configured to cause the gateway node to generate a local table based on the base station messages, the local table indicating the network IDs or Internet Protocol (IP) addresses of the base stations served by the gateway node. The computer program product may be further configured to cause the gateway node to send a table message to each or subset of a plurality of served base stations and/or neighboring gateway nodes, the table message including the local table. The computer program product may be further configured to cause the gateway node to receive a neighbor table message from each of the neighboring gateway nodes, the neighbor table messages including neighbor tables indicating network IDs or IP addresses of base stations served by each of the neighboring gateway nodes. The computer program product may be further configured to cause the gateway node to generate a global table based on the local table and the neighbor tables, the global table indicating, for each of the base stations served by the gateway node or the neighboring gateway nodes, the network ID or IP address of the base station and which gateway node(s) serves the base station.

According to another general aspect, a base station may include a transceiver, a controller, and a memory. The transceiver may be configured to receive at least one mobile station message from each of a plurality of mobile stations which each wirelessly communicate with the base station, the mobile station messages each including a network identification (ID) of the sending mobile station. The transceiver may be configured to send a table message to each or a subset of a plurality of neighboring base stations (such as base stations served by a common gateway node), the table message including a local table and network ID(s) or Internet Protocol (IP) addresses of the sending base station. The transceiver may be further configured to receive a neighbor table message from each or a subset of the neighboring base stations, the neighbor table messages including network ID(s) or Internet Protocol (IP) addresses of the neighboring base station and neighbor tables indicating network IDs or Internet Protocol (IP) addresses of mobile stations served by each of the neighboring base stations. The controller may be configured to generate a local table based on the mobile station messages and/or configuration information containing network IDs or Internet Protocol (IP) addresses of mobile stations served by the particular base station. The local table may indicate the network IDs or IP addresses of the mobile stations served by the base station. The controller may be further configured to generate a global table based on the local table and the neighbor tables. The global table may indicate, for each of the mobile stations served by the base station or the neighboring base stations, the network ID or IP address of the mobile station and which base station serves the mobile station. The memory may be configured to store the local table and the global table.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram showing an access service network according to an example embodiment.

FIG. 1B is a diagram showing a first wireless network served by a first base station and a second wireless network served by a second base station according to an example embodiment.

FIG. 2 shows a local table according to an example embodiment.

FIG. 3 is a block diagram showing a local table message according to an example embodiment.

FIG. 4 shows a neighbor table according to an example embodiment.

FIG. 5 is a block diagram showing a neighbor table message according to an example embodiment.

FIG. 6 shows a global table according to an example embodiment.

FIG. 7 is a block diagram showing a data message according to an example embodiment.

FIG. 8 shows a local base station table according to an example embodiment.

FIG. 9 shows a local mobile station table according to an example embodiment.

FIG. 10 is a block diagram showing a mobile station table message according to an example embodiment.

FIG. 11 is a block diagram showing a neighbor mobile station table message according to an example embodiment.

FIG. 12 shows a neighbor mobile station table according to an example embodiment.

FIG. 13 shows a global mobile station table according to an example embodiment.

FIG. 14 is a flowchart showing a method according to an example embodiment.

FIG. 15 is a block diagram showing a gateway node according to an example embodiment.

### DETAILED DESCRIPTION

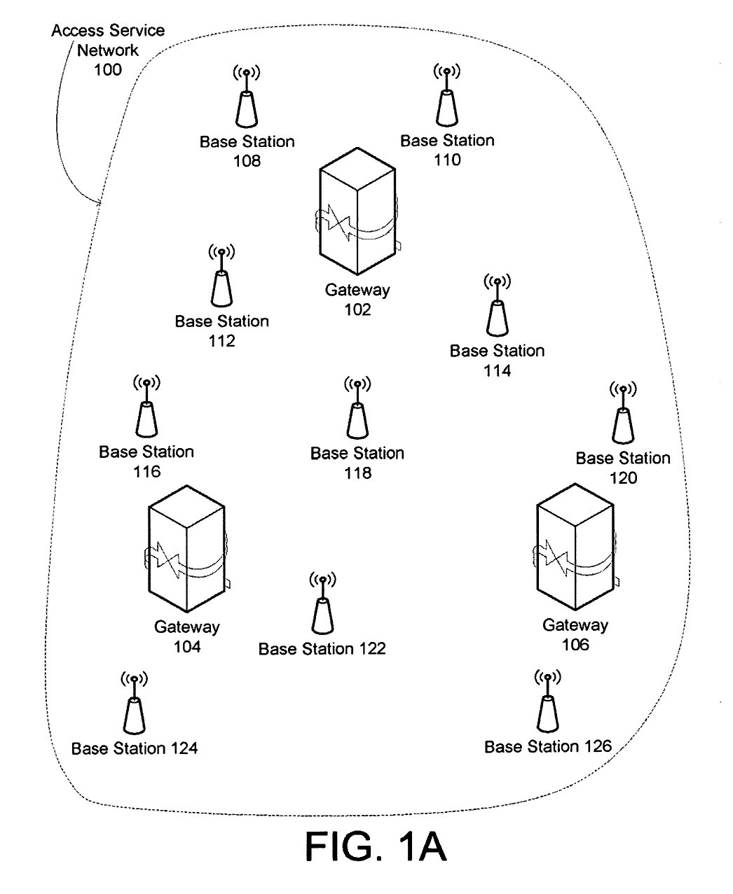

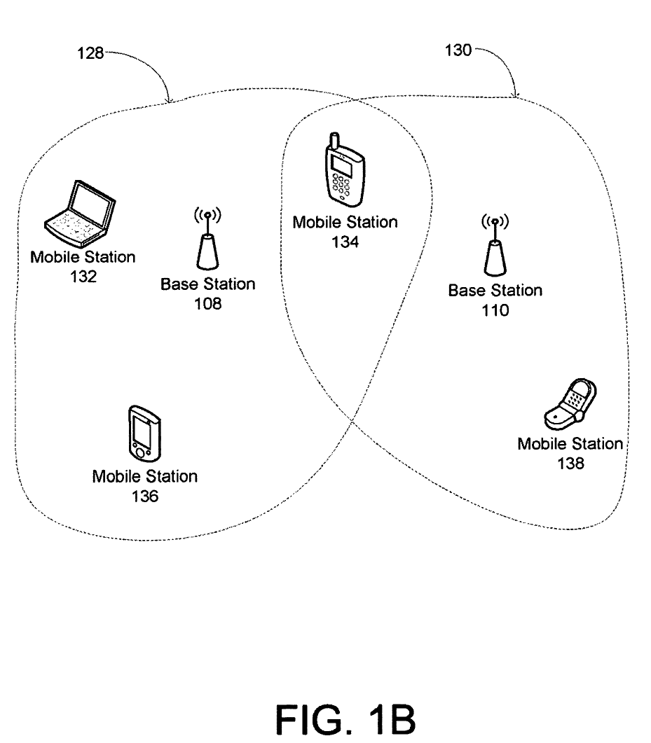

FIG. 1A is a diagram showing an access service network 100 according to an example embodiment. In this example, the access service network 100 may include a plurality of gateway nodes 102, 104, 106 which serve a plurality of base stations 108, 110, 112, 114, 116, 118, 120, 122, 124, 126. While three gateway nodes 102, 104, 106 and ten base stations 108, 110, 112, 114, 116, 118, 120, 122, 124, 126 are shown in FIG. 1A, any number of gateway nodes and base stations may be included in the access service network 100. The gateway nodes 102, 104, 106, which may include access service network (ASN) gateway nodes, may serve the plurality of base stations 108, 110, 112, 114, 116, 118, 120, 122, 124, 126 via wired (or guided) or wireless (or unguided) media, according to example embodiments. Each base station 108, 110, 112, 114, 116, 118, 120, 122, 124, 126 may be served by, and in communication with, a single gateway node, or a plurality of gateway nodes, according to example embodiments.

The base stations 108, 110, 112, 114, 116, 118, 120, 122, 124, 126 may include, for example, IEEE 802.16 Worldwide interoperability for Microwave Access (WiMAX) base stations, IEEE 802.11 Wireless Local Area Network (WLAN) Access Points (APs), cellular telephone network base stations, or Node Bs, according to example embodiments. The base stations 108, 110, 112, 114, 116, 118, 120, 122, 124, 126 may each serve and wirelessly communicate with a plurality of mobile stations. FIG. 1B is a diagram showing a first wireless network 128 served by a first base station 108 and a second wireless network 130 served by a second base station 110 according to an example embodiment. FIG. 1B shows the two base stations 108, 110 serving a total of four mobile stations 132, 134, 136, 138. However, the base stations 108, 110 may each serve any number of mobile stations 132, 134, 136, 138, according to various example embodiments. The mobile stations 132, 134, 136, 138 may include WiMAX subscriber stations, WLAN mobile stations, laptop or notebook computers, PDAs, smartphones, or cellular telephones, according to example embodiments.

The mobile stations 132, 134, 136, 138 may, according to an example embodiment, each be served by a single base station 108 at a given time. However, any of the mobile stations 132, 134, 136, 138 may be located in overlapping wireless networks 128, 130. In the example shown in FIG. 1B, the mobile station 134 is located in both the first wireless network 128 served by the first base station 108 and the second wireless network 130 served by the second base station 110. The mobile station 134 may be served by either the first base station 108 or the second base station 110, according to protocols established between the mobile stations 132, 134, 136, 138, base stations 108, 110, 112, 114, 116, 118, 120, 122, 124, 126, and/or gateway nodes 102, 104, 106, according to example embodiments. If, for example, the mobile station 134 moves away from the first base station 108 and toward the second base station 110, the first base station 108 may handover the mobile station 134 from the first base station 108 to the second base station 110 according to protocols established between the mobile station 134, the first and second base station 108, 110, and any or all of the gateway nodes 102, 104, 106 serving the first and second base station 108, 110.

When mobile stations 132, 134, 136, 138 and/or base stations 108, 110, 112, 114, 116, 118, 120, 122, 124, 126 send messages to other mobile stations 132, 134, 136, 138 and/or base stations 108, 110, 112, 114, 116, 118, 120, 122, 124, 126, it may be helpful for any or all of the base stations 108, 110, 112, 114, 116, 118, 120, 122, 124, 126 and/or gateways 102, 104, 106 to know the topology and/or hierarchy of the mobile stations 132, 134, 136, 138, base stations 108, 110, 112, 114, 116, 118, 120, 122, 124, 126, and/or gateway nodes 102, 104, 106 within the access service network 100. This knowledge of the topology and/or hierarchy may be helpful, for example, in routing messages, in determining which base station 108, 110, 112, 114, 116, 118, 120, 122, 124, 126 should serve a particular mobile station 132, 134, 136, 138 and/or in handover procedures. In an example embodiment, mobile stations 132, 134, 136, 138 and/or base stations 108, 110, 112, 114, 116, 118, 120, 122, 124, 126 may enter or exit the access service network 100 at various times, making it helpful to update the topology and/or hierarchy of the access service network at various times, such as periodically or upon detection of a change in the access service network 100 (such as when a mobile station 132, 134, 136, 138 and/or base station 108, 110, 112, 114, 116, 118, 120, 122, 124, 126 enters or exits the access service network 100).

In an example embodiment, any or all of the gateway nodes 102, 104, 106, such as the gateway node 102, may generate a local table of base stations 108, 110, 112, 114, 116, 118, 120, 122, 124, 126. The local table may include base stations which are served by the gateway node 102, such as, for example, base stations 108, 110, 112, 114, 118.

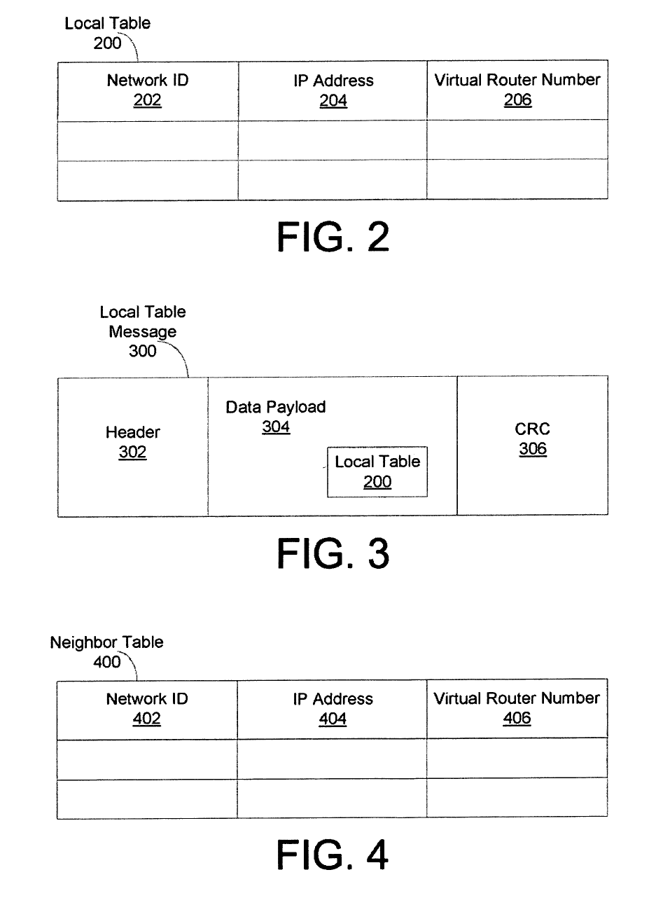

FIG. 2 shows a local table 200 according to an example embodiment. The local table 200 may include, for each of the base stations 108, 110, 112, 114, 118, a network identification (ID) 202 (which may include a network ID number), an Internet Protocol (IP) address 204, and/or a virtual network identifier 206. The network ID 202 may include a unique number assigned to each base station 108, 110, 112, 114, 116, 118, 120, 122, 124, 126 within the access service network 100, according to an example embodiment. The network ID 202 may, for example, include a medium access control (MAC) address of the respective base station 108, 110, 112, 114, 116, 118, 120, 122, 124, 126. In an example embodiment, the network ID 202 may include an operator-assigned ID of the respective base station 108, 110, 112, 114, 116, 118, 120, 122, 124, 126. Also in an example embodiment, different base stations may have different types of IDs some IDs may be based on base station MAC address, or some IDs may be assigned by an operator, without any restrictions, for example.

In an example embodiment, the gateway node 102 may receive base station messages from each of the base stations 108, 110, 112, 114, 118 served by the gateway node 102. The base station messages may be sent to the gateway node 102 by the base stations 108, 110, 112, 114, 118 at the start-up time, periodically, in response to a polling request by the gateway node 102, upon change detection, or when any of the base stations 108, 110, 112, 114, 118 has a message to send to another base station 108, 110, 112, 114, 116, 118, 120, 122, 124, 126 according to example embodiments. The base station messages received by the gateway node 102 may include the network ID 202 of the sending base station, such as in a header or a payload of the base station message.

In an example embodiment, the gateway node 102 may generate the local table 200 with the network IDs 202 identifying the base stations 108, 110, 112, 114, 118 served by the gateway node 102 based on the base station messages. The local table 200 may also include other information associated with each of the base stations 108, 110, 112, 114, 118 served by the gateway node 102, such as location. The location of the respective base stations 108, 110, 112, 114, 118 may be included in the base station messages, according to an example embodiment. The respective base stations 108, 110, 112, 114, 118 may determine their locations based, for example, on a global positioning system (GPS) unit.

In an example embodiment, the gateway node 102 may store the IP address 202 and the virtual network identifier 206 in the local table 200 in addition to, or instead of, the network ID. Each network ID 202 may, for example, be associated with a single IP address 204. The virtual network identifier 206 may be the same for each node (e.g., mobile stations 132, 134, 136, 138, base stations 108, 110, 112, 114, 116, 118, 120, 122, 124, 126, and/or gateway nodes 102, 104, 106) within the access service network 100, and may serve to distinguish the nodes within the access service network 100 from nodes outside the access service network 100 which may have the same IP address 204. In an example embodiment, the gateway node 102 may store the association between the network IDs 202 and the IP addresses 204, and may convert the network IDs 202 into the IP addresses 204, and may generate the local table 200 based on the base station messages, the local table 200 indicating the IP addresses 204 and virtual network identifier 206 of the base stations 108, 110, 112, 114, 118 served by the gateway node 102. In another example embodiment, the base station messages may include the IP address 204 associated with each of the base stations 108, 110, 112, 114, 118, and the gateway node 102 may or may not convert the IP addresses 204 to network IDs 202.

In an example embodiment, the gateway nodes 102, 104, 106 may share their local tables 200 with each other to generate a global table. For example, the gateway node 102 may send to the other gateway nodes 104, 106 within the access service network 100, which may be considered neighboring gateway nodes, a local table message which includes the local table 200. The neighboring gateway nodes may include the gateway nodes 104, 106 to which the gateway node 102 is communicatively coupled; in the example of a mesh network topology between the gateway nodes 102, 104, 106, the neighboring gateway nodes may include all of the other gateway nodes 104, 106 within the access service network 100. The gateway nodes 102, 104, 106 may also share their local and/or global tables with served base stations 108, 110, 112, 114, 118 to enable capability of direct communication between base stations without gateway involvement, according to an example embodiment.

FIG. 3 is a block diagram showing a local table message 300 according to an example embodiment. The local table message 300 may include, for example, a header 302. The header 302 may include a medium access control (MAC) header or IP header, and may include, for example, a source address and a destination address for the local table message 300. The source address may identify the gateway node 102 which sent the local table message 300, and the destination address may identify the gateway node 104, 106 to which the local table message 300 is sent. The source and destination addresses may include network IDs or IP addresses and virtual network identifiers of the gateway nodes 102, 104, 106.

The local table message 300 may also include a data payload 304. The data payload may include the local table 200 generated by the gateway node 102. The local table 200 may be included in a single local table message 300, or may be divided and sent via a plurality of local table messages 300, according to example embodiments. The local table message 300 may also include a cyclic redundancy code (CRC) 306. The CRC 306 may, for example, include a frame check sequence for error detection.

Other gateway nodes 104, 106 within the access service network 100 may also generate neighbor tables in a similar manner to the gateway node 102 generating the local table 200. FIG. 4 shows a neighbor table 400 according to an example embodiment. The neighbor table 400 may include, for example, network IDs 402 and/or IP addresses 404 and virtual network identifiers 406 for each of the base stations 108, 110, 112, 114, 116, 118, 120, 122, 124, 126 served by the respective gateway node 104, 106. Each neighbor table 400 may also include other information associated with each of the base stations 108, 110, 112, 114, 116, 118, 120, 122, 124, 126 served by the respective gateway node 104, 106, such as location.

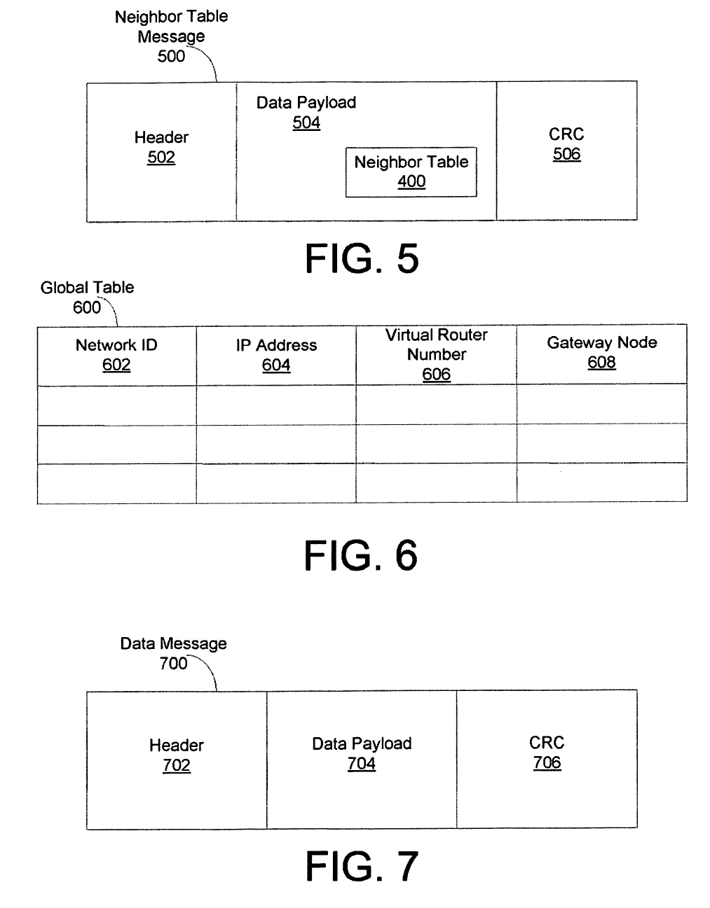

The other gateway nodes 104, 106 may send local table messages 300 to each other and to the gateway node 102. When received, the local table message 300 may be considered a neighbor table message. FIG. 5 is a block diagram showing a neighbor table message 500 according to an example embodiment. The neighbor table message 500 may include, for example, a header 502. The header 502 may include a MAC header or IP header, and may include a source address and a destination address for the neighbor table message 500, such as network IDs or IP addresses and virtual network identifiers of the gateway nodes 102, 104, 106. The neighbor table message 500 may also include a data payload 504. The data payload 504 may include the local table 200 generated by the sending gateway node 104, 106. The local table 200 may be included in a single neighbor table message 500, or may be divided and sent via a plurality of neighbor table messages 500, according to example embodiments. The neighbor table message 500 may also include a CRC 506. The CRC 506 may, for example, include a frame check sequence for error detection.

Each gateway node 102, 104, 106, such as the gateway node 102, may generate a global table based on the local table 200 and the received neighbor tables 400. FIG. 6 shows a global table 600 according to an example embodiment. In an example embodiment, the global table 600 may indicate, for each base station 108, 110, 112, 114, 116, 118, 120, 122, 124, 126 served by the gateway node 102 or neighboring gateway nodes 104, 106, the network ID 602 of the base station 108, 110, 112, 114, 116, 118, 120, 122, 124, 126 and/or the IP address 604 and virtual network identifier 606 of the base station 108, 110, 112, 114, 116, 118, 120, 122, 124, 126. The global table 600 may also indicate, for each base station 108, 110, 112, 114, 116, 118, 120, 122, 124, 126, a gateway node 608 which serves the base station 108, 110, 112, 114, 116, 118, 120, 122, 124, 126. In an example in which any or all of the base stations 108, 110, 112, 114, 116, 118, 120, 122, 124, 126 may be served by more than one gateway node 102, 104, 106, the global table 600 may indicate more than one gateway node 608 for any or all of the base stations 108, 110, 112, 114, 116, 118, 120, 122, 124, 126.

In an example embodiment, the gateway nodes 102, 104, 106 may iteratively generate the global table 600 based on the global table 600 and updated neighbor tables 400. For example, the gateway nodes 102, 104, 106 may send subsequent table messages to the neighboring gateway nodes 102, 104, 106 and/or served base stations 108, 110, 112, 114, 116, 118, 120, 122, 124, 126. The subsequent table messages may include the global table 600. The gateway nodes 102, 104, 106 may also receive subsequent neighbor table messages from each of the neighboring gateway nodes 102, 104, 106. The subsequent neighbor table messages may include updated neighbor tables (which may include the global tables 600 generated by the neighboring gateway nodes 102, 104, 106). The updated neighbor tables may indicate network IDs or IP addresses of base stations 108, 110, 112, 114, 116, 118, 120, 122, 124, 126 served by the neighboring gateway nodes 102, 104, 106 which sent the subsequent neighbor table messages. The subsequent neighbor table messages may also include network IDs or IP addresses of base stations served by gateway nodes which neighbor the gateway nodes 102, 104, 106 (such as in a partial mesh topology access service network). The global table 600 may be iteratively generated based on the global table 600 and updated neighbor tables until subsequent neighbor tables do not include any new base stations, or any new network IDs or IP addresses of base stations, according to an example embodiment.

In an example embodiment, the gateway nodes 102, 104, 106 may route messages, such as data messages, based on the global table 600. FIG. 7 is a block diagram showing a data message 700 according to an example embodiment. In this example, the data message 700 may include a header 702. The header 702 may include a MAC header or IP header and may include, for example, a source address and a destination address. The source address may indicate a network ID or IP address and virtual network identifier of an originating node of the data message 700, such as a mobile station 132, 134, 136, 138 or a base station 108, 110, 112, 114, 116, 118, 120, 122, 124, 126. The destination address may indicate a network ID or IP address and virtual network identifier of a destination node of the data message 700, such as a mobile station 132, 134, 136, 138 or a base station 108, 110, 112, 114, 116, 118, 120, 122, 124, 126. The data message 700 may also include a data payload 704. The data payload 704 may include, for example, data to be sent to another node in the access service network 100. The data message 700 may also include a CRC 706, which may include a frame check sequence for error detection.

The gateway node 102, 104, 106 which receives the data message 700 may, for example, look the destination address up on the global table 600, and route the data message 700 to a gateway node 102, 104, 106 based on the gateway node 608 indicated by the global table 600. According to an example embodiment, the gateway node 102 may route the data message 700 to at least one of the neighboring gateway nodes 104, 106 or at least one of the served base station 108, 110, 112, 114, 118 based on the destination address and the global table 600.

In an example embodiment, the gateway nodes 102, 104, 106 may also generate tables indicating the topology and/or hierarchy of the mobile stations 132, 134, 136, 138 in the access service network 100. The base stations 108, 110, 112, 114, 116, 118, 120, 122, 124, 126 may, for example, determine the network IDs and/or IP addresses and virtual network identifiers of mobile stations 132, 134, 136, 138 within their respective wireless networks 128, 130. In an example embodiment, the base stations 108, 110, 112, 114, 116, 118, 120, 122, 124, 126 may also determine the locations of mobile stations 132, 134, 136, 138 within their respective wireless networks 128, 130. The base stations 108, 110, 112, 114, 116, 118, 120, 122, 124, 126 may generate local base station tables which include a list of mobile stations 132, 134, 136, 138 within their respective wireless networks 128, 130 and/or served by the respective base stations 108, 110, 112, 114, 116, 118, 120, 122, 124, 126.

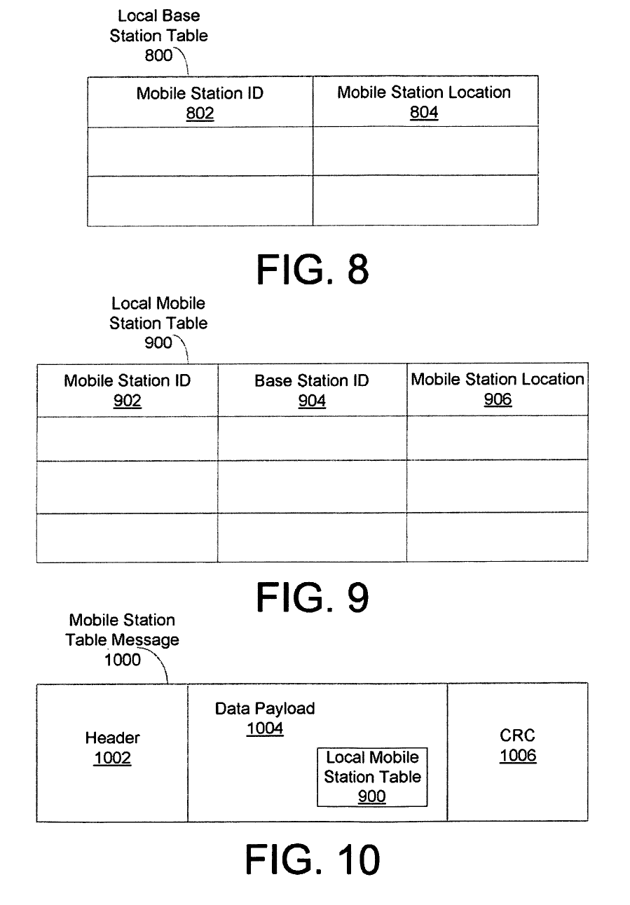

FIG. 8 shows a local base station table 800 according to an example embodiment. In this example, the local base station table 800 may include, for each mobile station 132, 134, 136, 138 served by the respective base station 108, 110, 112, 114, 116, 118, 120, 122, 124, 126, a mobile station ID 802 and a mobile station location 804. The mobile station ID may include the network ID and/or the IP address and virtual network identifier of the respective mobile station 132, 134, 136, 138. The mobile station location 804 may indicate a geographic location of the respective mobile station 132, 134, 136, 138 based, for example, on input received from a GPS unit or based on relative received signal strengths from other mobile stations 132, 134, 136, 138 and/or base stations 108, 110, 112, 114, 116, 118, 120, 122, 124, 126.

The base stations 108, 110, 112, 114, 116, 118, 120, 122, 124, 126 may send their respective local base station tables 800 to the gateway node(s) 102, 104, 106 which serves them. The base stations 108, 110, 112, 114, 116, 118, 120, 122, 124, 126 may, for example, include the local base station table 800 in the data payload 704 of a data message 700 sent to the serving gateway node 102, 104, 106.

The gateway nodes 102, 104, 106 may receive the local base station tables 800 from the base stations 108, 110, 112, 114, 116, 118, 120, 122, 124, 126 which the gateway nodes 102, 104, 106 respectively serve, and may generate local mobile station tables based on the received local base station tables 800. FIG. 9 shows a local mobile station table 900 according to an example embodiment. The local mobile station table 900 may, for example, include all mobile stations 132, 134, 136, 138 served by base stations base stations 108, 110, 112, 114, 116, 118, 120, 122, 124, 126 which are served by the gateway node 102, 104, 106 which generated the local mobile station table 900. The gateway node 102, 104, 106 may generate the local mobile station table 900 based on the received local base station tables 800.

In the example shown in FIG. 9, the local mobile station table 900 includes, for each mobile station 132, 134, 136, 138, a mobile station ID 902, a base station ID 904, and a mobile station location 906. The mobile station ID 902 may identify the respective mobile station 132, 134, 136, 138 by network ID and/or IP address and virtual network identifier. The base station ID 904 may identify the base station(s) 108, 110, 112, 114, 116, 118, 120, 122, 124, 126 serving the respective mobile station 132, 134, 136, 138 by network ID and/or IP address and virtual network identifier. The mobile station location 906 may indicate a location of the respective mobile station 132, 134, 136, 138.

In an example embodiment, the gateway nodes 102, 104, 106 may exchange local mobile station tables 900 to generate global mobile station tables. For example, the gateway node 102 may send a mobile station table message to each of its neighboring gateway nodes 104, 106 and/or each of served base stations 108, 110, 112, 114, 118. FIG. 10 is a block diagram showing a mobile station table message 1000 according to an example embodiment. In this example, the mobile station table message 1000 may include a header 1002, a data payload 1004, and a CRC 1006. The header 1002, which may include MAC header or an IP header, may include a source address of the sending gateway node 102 and a destination address of the receiving gateway node 104, 106. The source address and destination address may include, for example, network IDs and/or IP addresses and virtual network identifiers of the respective gateway nodes 102, 104, 106. The data payload 1004 may include the local mobile station table 900, according to an example embodiment. The local mobile station table 900 may be included in a single mobile station table message 1000, or may be divided and sent via a plurality of mobile station table messages 1000, according to example embodiments. The CRC 1006 may include a frequency check sequence for error detection, according to an example embodiment.

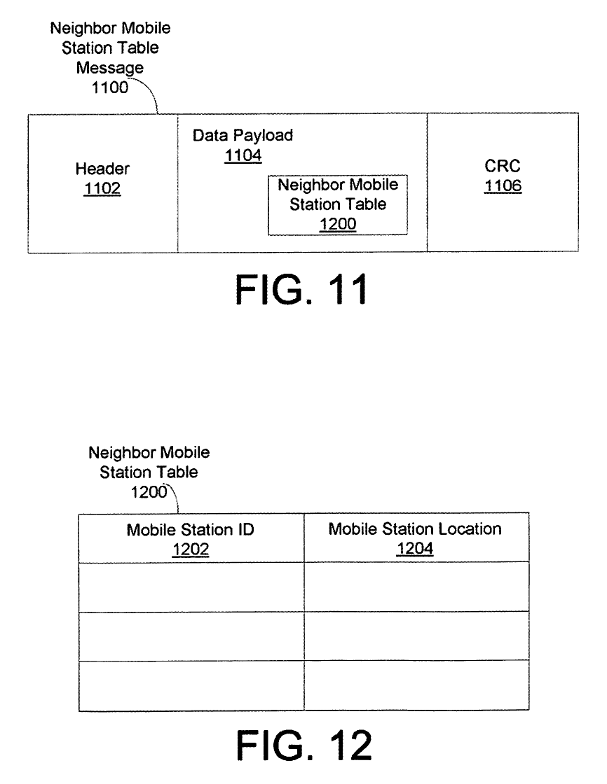

In an example embodiment, the neighboring gateway nodes 104, 106 may send neighbor mobile station table messages to each other, to the gateway node 102 and to served base stations 116, 118, 120, 122, 124, 126. FIG. 11 is a block diagram showing a neighbor mobile station table message 1100 according to an example embodiment. In this example, the neighbor mobile station table message 1100 may include a header 1102, a data payload 1104, and a CRC 1106. The header 1102 may include a MAC header or an IP header, and may include a source address of the sending gateway node 104, 106 and a destination address of the receiving gateway node 102. The source address and destination address may include, for example, network IDs and/or IP addresses and virtual network identifiers of the respective gateway nodes 102, 104, 106. The data payload 1104 may include the neighbor mobile station table (described with reference to FIG. 12), according to an example embodiment. The neighbor mobile station table may be included in a single neighbor mobile station table message 1100, or may be divided and sent via a plurality of neighbor mobile station table messages 1100, according to example embodiments. The CRC 1106 may include a frequency check sequence for error detection, according to an example embodiment.

FIG. 12 shows a neighbor mobile station table 1200 according to an example embodiment. The neighbor mobile station table 1200 may include, for each mobile station 132, 134, 136, 138 served by a base station 108, 110, 112, 114, 116, 118, 120, 122, 124, 126 served by the respective gateway node 104, 106, a mobile station ID 1202, a base station ID 1204, and a mobile station location 1206. The gateway nodes 104, 106 may generate the mobile station ID 1202, base station ID 1204, and mobile station ID 1206 in a manner similar to the gateway node 102 generating the mobile station ID 902, base station ID 904, and mobile location 906, according to an example embodiment.

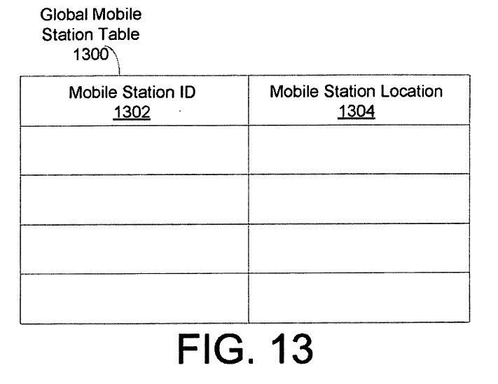

The gateway node 102 may receive the neighbor mobile station messages 1100 from the neighboring gateway nodes 104, 106, and generate a global mobile station table based on the local mobile station table 900 and the neighbor mobile station tables 1200. FIG. 13 shows a global mobile station table 1300 according to an example embodiment. In this example, the global mobile station 1300 may include, for each mobile station 132, 134, 136, 138 in the access service network 100, the mobile station ID 1302, a base station ID(s) 1304 of the base station 108, 110, 112, 114, 116, 118, 120, 122, 124, 126 serving the respective mobile station 132, 134, 136, 138, a gateway node ID(s) 136 of the gateway node(s) 102, 104, 106 serving the base station(s) 108, 110, 112, 114, 116, 118, 120, 122, 124, 126 which serves the respective mobile station 132, 134, 136, 138, and a mobile station location 138 indicating a location of the respective mobile station 132, 134, 136, 138. The mobile station ID 1302, base station 1304, and gateway node ID 1306 may include network IDs and/or IP addresses and virtual network identifiers of the respective nodes.

In an example embodiment, a gateway node 102, 104, 106 may route a data message 700, which may have originated from either a mobile station 132, 134, 136, 138 or a base station 108, 110, 112, 114, 116, 118, 120, 122, 124, 126 and be destined for a mobile station 132, 134, 136, 138, based on the global mobile station table 1300. For example, the gateway node 102 may receive a data message 700 from one of the base stations 108, 110, 112, 114, 116, 118, 120, 122, 124, 126 served by the gateway node 102 and route the data message 700 to at least one of the neighboring gateway nodes 104, 106 or served based stations 108, 110, 112, 114, 118 based on the destination address included in the header 702 and the global mobile station table 1300. Or, the gateway node 102 may receive a data message 700 from one of the base stations 108, 110, 112, 114, 116, 118, 120, 122, 124, 126 served by the gateway node 102 and instruct the base station 108, 110, 112, 114, 116, 118, 120, 122, 124, 126 to permit the originating mobile station 132, 134, 136, 138 to engage in peer-to-peer communication with the mobile station 132, 134, 136, 138 for which the data message 700 is intended based on the source address and destination address included in the header 702 and on the global mobile station table 1300. The gateway node 102 may instruct the base station 108, 110, 112, 114, 116, 118, 120, 122, 124, 126 to permit the peer-to-peer communication based, for example, on the respective locations of the mobile nodes 132, 134, 136, 138.

In an example embodiment, the gateway node 102 may send the global table 600 and/or global mobile station table 1300 to the base stations 108, 110, 112, 114, 118 served by the gateway node 102. The base stations 108, 110, 112, 114, 116, 118, 120, 122, 124, 126 may receive the global table 600 and/or global mobile station table 1300 and determine the topology and/or hierarchy of the nodes in the access service network 100. The base stations 108, 110, 112, 114, 116, 118, 120, 122, 124, 126 may, for example, perform handovers of mobile stations 132, 134, 136, 138 based on the information included in the global table 600 and/or global mobile station table 1300. Or, the base stations 108, 110, 112, 114, 116, 118, 120, 122, 124, 126 may use the information in the global table 600 and/or global mobile station table 1300 to serve as routers, according to example embodiments.

In an example embodiment, the base stations 108, 110, 112, 114, 116, 118, 120, 122, 124, 126 may also generate mobile station tables. For example, the base stations 108, 110, 112, 114, 116, 118, 120, 122, 124, 126 may exchange local base station tables 800 with each other via peer-to-peer communication in a similar manner to the gateway nodes 102, 104, 106 exchanging local tables 200 or local mobile stations 900. The base stations 108, 110, 112, 114, 116, 118, 120, 122, 124, 126 may generate base station tables identifying mobile stations 132, 134, 136, 138 served by base stations 108, 110, 112, 114, 116, 118, 120, 122, 124, 126 within the wireless access network 100, or identifying mobile stations 132, 134, 136, 138 served by base stations 108, 110, 112, 114, 116, 118, 120, 122, 124, 126 which are served by a particular gateway node 102, 104, 106, according to example embodiments. The base stations 108, 110, 112, 114, 116, 118, 120, 122, 124, 126 may generate these base station tables based on their local base station tables 800 and the tables received from the other base stations 108, 110, 112, 114, 116, 118, 120, 122, 124, 126, according to an example embodiment.

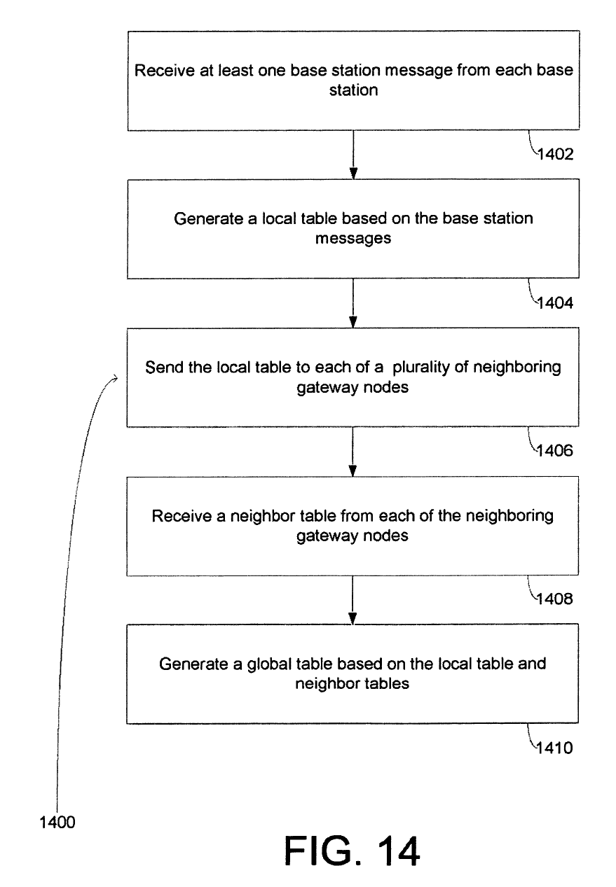

FIG. 14 is a flowchart showing a method 1400 according to an example embodiment. The method 1400 may include receiving, by a gateway node 102, 104, 106 serving a plurality of base stations 108, 110, 112, 114, 116, 118, 120, 122, 124, 126 which each wirelessly communicate with a plurality of mobile stations 132, 134, 136, 138, at least one base station message from each of the base stations 108, 110, 112, 114, 116, 118, 120, 122, 124, 126 (1402). The base station messages may each include a network identification (ID) of the sending base station 108, 110, 112, 114, 116, 118, 120, 122, 124, 126.

The method 1400 may also include generating a local table 200 based on the base station messages (1404). The local table 200 may indicate the network IDs or Internet Protocol (IP) addresses of the base stations 108, 110, 112, 114, 116, 118, 120, 122, 124, 126 served by the gateway node 102, 104, 106. The method 1400 may also include sending a local table message 300 to each or subset of a plurality of neighboring gateway nodes 102, 104, 106 and served base stations 108, 110, 112, 114, 116, 118, 120, 122, 124, 126 (1406). The local table message 300 may include the local table 200.

The method 1400 may also include receiving a neighbor table message 500 from each of the neighboring gateway nodes 102, 104, 106 (1408). The neighbor table messages 500 may include neighbor tables 400 indicating network IDs or IP addresses of base stations 108, 110, 112, 114, 116, 118, 120, 122, 124, 126 served by each of the neighboring gateway nodes.

The method 1400 may also include generating a global table 600 based on the local table 200 and the neighbor tables 400 (1410) The global table 600 may indicate, for each of the base stations 108, 110, 112, 114, 116, 118, 120, 122, 124, 126 served by the gateway node 102, 104, 106 or neighboring gateway nodes 102, 104, 106, the network ID or IP address of the base station 108, 110, 112, 114, 116, 118, 120, 122, 124, 126 and which gateway node(s) 102, 104, 106 serves the base station 108, 110, 112, 114, 116, 118, 120, 122, 124, 126.

In example embodiments, generating the tables (such as the local table 200, neighbor table 400, global table 600, local base station table 800, local mobile station table 900, neighbor mobile station table 1200, and/or global mobile station table 1300) and/or the messages (such as the local table message 300, neighbor table message 500, data message 700, mobile station table message 1000, and/or neighbor mobile station table message 1100) may be performed according to routing protocols, such as Open Shortest Path First (OSPF) or Border Gateway Protocol (BGP). The virtual network ID of any of the nodes may, for example, be mapped into a virtual router (VR) ID.

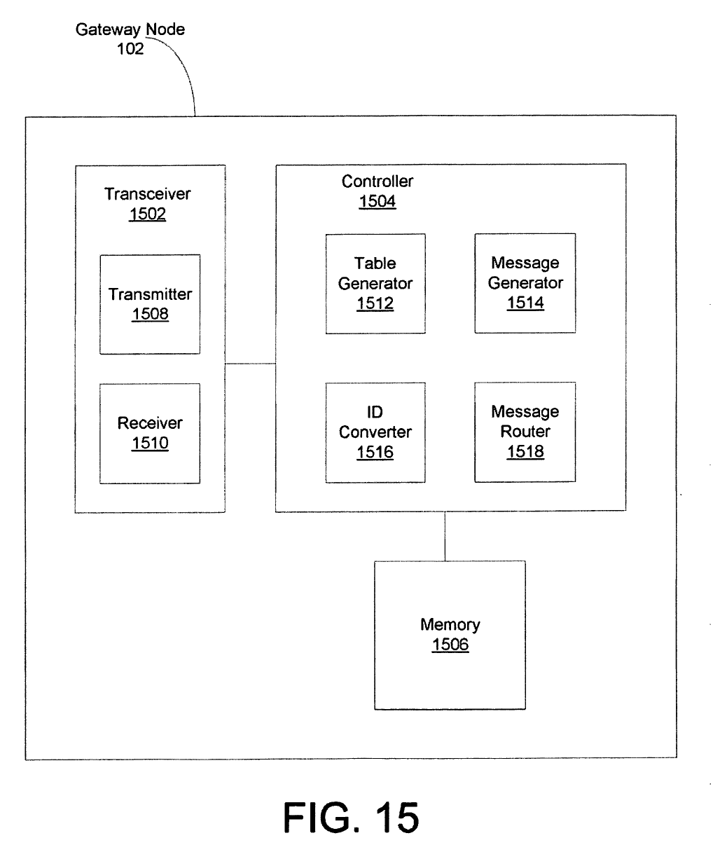

FIG. 15 is a block diagram showing a gateway node 102 according to an example embodiment. In this example, the gateway node 102 may include a transceiver 1502 coupled to a controller 1504, the controller 1504 coupled to a memory 1506, and the memory. The transceiver 1502 may be capable of both transmitting and receiving messages or signals, including those described above. The transceiver 1502 may include a single component, or may include both a transmitter 1508 and a receiver 1510 as separate components. The controller 1504 may include, for example, a table generator 1512 configured to generate, for example, the local table 200, the local mobile station table 900, and/or global mobile station table 1300. The controller 1504 may also include a message generator configured to generate, for example, local table messages 300, data messages 700, and/or mobile station table messages 1000. The controller 1504 may also include an ID converter 1516 configured to convert node IDs between network IDs and IP addresses and virtual network identifiers. The controller 1504 may also include a message router 1518 configured to route the messages based on source and/or destination addresses and the local table 200, local mobile station table 900, and/or global mobile station table 1300. The memory 1506 may be configured to store network IDs, IP addresses, virtual network identifiers, and tables and messages described above. While FIG. 15 has been described with reference to a gateway node 102, a base station 108, 110, 112, 114, 116, 118, 120, 122, 124, 126 as described above may also include a transceiver 1502, controller 1504, and memory 1506 with similar features and capabilities to those described above, according to an example embodiment.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, implementing the processes described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
receiving, by a gateway node serving a plurality of base stations which each wirelessly communicate with a plurality of mobile stations, at least one base station message from each of the base stations, the base station messages each including a network identification (ID) of the sending base station;
generating a local table based on the base station messages, the local table indicating the network IDs or Internet Protocol (IP) addresses of the base stations served by the gateway node;
sending the local table to each of a plurality of neighboring gateway nodes;
receiving neighbor tables from each of the neighboring gateway nodes, the neighbor tables indicating network IDs or IP addresses of base stations served by each of the neighboring gateway nodes; and
generating a global table based on the local table and the neighbor tables, the global table indicating, for each of the base stations served by the gateway node or the neighboring gateway nodes, the network ID or IP address of the base station and which gateway node(s) serves the base station.

2. The method of claim 1, wherein the receiving includes receiving, by a Worldwide Interoperability for Microwave Access (WiMAX) access service network gateway node, the at least one base station message from each of the base stations.

3. The method of claim 1, further comprising:
converting the network IDs of each of the base stations to IP addresses;
wherein the generating the local table includes generating the local table based on the base station messages, the local table indicating the IP addresses and a virtual network identifier of the base stations served by the gateway node.

4. The method of claim 3, wherein:
the receiving the neighbor table includes receiving the neighbor table from each of the neighboring gateway nodes, the neighbor tables indicating IP addresses and the virtual network identifier of the base stations served by each of the neighboring gateway nodes; and
the generating the global table includes generating the global table based on the local table and the neighbor tables, the global table indicating, for each of the base stations served by the gateway node or the neighboring gateway nodes, the IP address and the virtual network identifier of the base station and which gateway node(s) serves the base station.

5. The method of claim 1, further comprising:
sending the global table to the neighboring gateway nodes; and
receiving updated neighbor tables from each of the neighboring gateway nodes, the updated neighbor tables indicating networks IDs or IP addresses of base stations served by each of the neighboring gateway nodes and by gateway nodes which neighbor the neighboring gateway nodes;
wherein the generating the global table includes iteratively generating the global table based on the global table and the updated neighbor tables until the subsequent neighbor tables do not include any new base stations.

6. The method of claim 1, further comprising:
receiving a data message from one of the base stations served by the gateway node, the data message including data and a destination address, the destination address indicating a network ID of a base station for which the data message is intended; and
routing the data message to at least one of the neighboring gateway nodes based on the destination address and the global table.

7. The method of claim 1, further comprising:
receiving local base station tables from each of the base stations served by the gateway node, the local base station tables each including a list of mobile stations served by the respective base station; and
generating a local mobile station table based on the received local base station tables, the local mobile station table including a list of mobile stations served by the plurality of base stations which are served by the gateway node.

8. The method of claim 7, further comprising:
sending the local mobile station table to each of the neighboring gateway nodes;
receiving neighbor mobile station tables from each of the neighboring gateway nodes, the neighbor mobile station tables indicating mobile stations served by the base stations served by the neighboring gateways; and
generating a global mobile station table based on the local mobile station table and the neighbor mobile station tables.

9. The method of claim 8, further comprising:
receiving a data message from one of the base stations served by the gateway node, the data message including data and a destination address, the destination address identifying a mobile station for which the data message is intended; and
routing the data message to at least one of the neighboring gateway nodes based on the destination address and the global mobile station table.

10. The method of claim 8, further comprising:
receiving a data message from one of the base stations served by the gateway node, the data message including data, a source address, and a destination address, the source address identifying a mobile station which generated the data message and the destination address identifying a mobile station for which the data message is intended; and
instructing the base station to permit the mobile station which generated the data message to engage in peer-to-peer communication with the mobile station for which the data message is intended based on the source address, the destination address, and the global mobile station table.

11. A gateway node comprising:
a transceiver configured to:
receive at least one base station message from each of a plurality of base stations which each wirelessly communicate with a plurality of mobile stations, the base station messages each including a network identification (ID) of the sending base station;
send a local table to each of a plurality of neighboring gateway nodes; and
receive a neighbor table from each of the neighboring gateway nodes, the neighbor tables indicating network IDs or Internet Protocol (IP) addresses of base stations served by each of the neighboring gateway nodes;
a controller configured to:
generate the local table based on the base station messages, the local table indicating the network IDs or IP addresses of the base stations served by the gateway node; and
generate a global table based on the local table and the neighbor tables, the global table indicating, for each of the base stations served by the gateway node or the neighboring gateway nodes, the network ID or IP address of the base station and which gateway node(s) serves the base station; and
a memory configured to store the local table and the global table.

12. The gateway node of claim 11, wherein the gateway node includes a Worldwide interoperability for Microwave Access (WiMAX) access service network gateway node.

13. The gateway node of claim 11, wherein the controller is configured to:
convert the network IDs of each of the base stations to IP addresses; and
generate the local table based on the base station messages, the local table indicating the IP addresses and a virtual network identifier of the base stations served by the gateway node.

14. The gateway node of claim 11, wherein the controller is configured to:
convert the network IDs of each of the base stations to IP addresses;
generate the local table based on the base station messages, the local table indicating the IP addresses and a virtual network identifier of the base stations served by the gateway node; and
generate the global table based on the local table and the neighbor tables, the global table indicating, for each of the base stations served by the gateway node or the neighboring gateway nodes, the IP address and the virtual network identifier of the base station and which gateway node(s) serves the base station.

15. The gateway node of claim 11, wherein:
the transceiver is further configured to:
send the global table to the neighboring gateway nodes; and
receive subsequent updated neighbor tables from each of the neighboring gateway nodes, the subsequent updated neighbor tables indicating network IDs or IP addresses of base stations served by each of the neighboring gateway nodes and by gateway nodes which neighbor the neighboring gateway nodes; and
the controller is further configured to:
generate the global table by iteratively generating the global table based on the global table and the updated neighbor tables until the subsequent neighbor table messages do not include any new base stations.

16. The gateway node of claim 11, wherein the transceiver is further configured to:
receive a data message from one of the base stations served by the gateway node, the data message including data and a destination address, the destination address indicating a network ID of a base station for which the data message is intended; and
route the data message to at least one of the neighboring gateway nodes based on the destination address and the global table.

17. The gateway node of claim 11, wherein:
the transceiver is further configured to receive local base station tables from each of the base stations served by the gateway node, the local base station tables each including a list of mobile stations served by the respective base station;
the controller is further configured to generate a local mobile station table based on the received local base station tables, the local mobile station table including a list of mobile stations served by the plurality of base stations which are served by the gateway node; and
the memory is further configured to store the local mobile station table.

18. The gateway node of claim 17, wherein:
the transceiver is further configured to:
send the local mobile station table to each of the neighboring gateways; and
receive neighbor mobile station tables from each of the neighboring gateways, the neighbor mobile station tables indicating mobile stations served by the base stations served by the neighboring gateways;
the controller is further configured to generate a global mobile station table based on the local mobile station table and the neighbor mobile station tables; and
the memory is further configured to store the global mobile station table.

19. The gateway node of claim 11, wherein the transceiver is further configured to:
receive a data message from one of the base stations served by the gateway node, the data message including data and a destination address, the destination address identifying a mobile station for which the data message is intended; and
route the data message to at least one of the neighboring gateway nodes based on the destination address and the global mobile station table.

20. The gateway node of claim 11, wherein the transceiver is further configured to:
receive a data message from one of the base stations served by the gateway node, the data message including data, a source address, and a destination address, the source address identifying a mobile station which generated the data message and the destination address identifying a mobile station for which the data message is intended; and
instruct the base station to permit the mobile station which generated the data message to engage in peer-to-peer communication with the mobile station for which the data message is intended based on the source address, the destination address, and the global mobile station table.

21. A computer program product for generating a global table of base stations, the computer program product being tangibly embodied on a computer-readable medium and including executable code that, when executed, is configured to cause a gateway node which serves a plurality of base stations which each wirelessly communicate with a plurality of mobile stations to:
receive at least one base station message from each of the base stations, the base station messages each including a network identification (ID) of the sending base station;
generate a local table based on the base station messages, the local table indicating the network IDs or Internet Protocol (IP) addresses of the base stations served by the gateway node;
send the local table to each of a plurality of neighboring gateway nodes;
receive a neighbor table from each of the neighboring gateway nodes, the neighbor tables indicating network IDs or IP addresses of base stations served by each of the neighboring gateway nodes; and
generate a global table based on the local table and the neighbor tables, the global table indicating, for each of the base stations served by the gateway node or the neighboring gateway nodes, the network ID or IP address of the base station and which gateway node(s) serves the base station.

22. The computer program product of claim 21, wherein the computer program product is configured to be installed on a Worldwide interoperability for Microwave Access (WiMAX) access service network gateway node.

23. The computer program product of claim 21, wherein the computer program product is further configured to cause the gateway node to:
convert the network IDs of each of the base stations to IP addresses;
wherein the generating the local table includes generating the local table based on the base station messages, the local table indicating the IP addresses and a virtual network identifier of the base stations served by the gateway node.

24. The computer program product of claim 21, wherein:
the receiving the neighbor table message includes receiving the neighbor table message from each of the neighboring gateway nodes, the neighbor table messages including neighbor tables indicating IP addresses and the virtual network identifier of the base stations served by each of the neighboring gateway nodes; and
the generating the global table includes generating the global table based on the local table and the neighbor tables, the global table indicating, for each of the base stations served by the gateway node or the neighboring gateway nodes, the IP address and the virtual network identifier of the base station and which gateway node(s) serves the base station.

25. A base station comprising:
a transceiver configured to:
receive at least one mobile station message from each of a plurality of mobile stations which each wirelessly communicate with the base station, the mobile station messages each including a network identification (ID) of the sending mobile station;
send a local table to each of a plurality of neighboring base stations; and
receive a neighbor table from each of the neighboring base stations, the neighbor tables indicating network IDs or Internet Protocol (IP) addresses of mobile stations served by each of the neighboring mobile stations;
a controller configured to:
generate the local table based on the mobile station messages, the local table indicating the network IDs or IP addresses of the mobile stations served by the base station; and
generate a global table based on the local table and the neighbor tables, the global table indicating, for each of the mobile stations served by the base station or the neighboring base stations, the network ID or IP address of the mobile station and which base station serves the mobile station; and
a memory configured to store the local table and the global table.
